(19) United States
(12) Patent Application Publication
(10) Pub. No.: US 2025/0110260 A1
(43) Pub. Date: Apr. 3, 2025

(54) FLUORINE-CONTAINING RESIN COMPOSITION FOR PLASTIC OPTICAL FIBERS, PLASTIC OPTICAL FIBER OR RESIN ROD FOR PLASTIC OPTICAL FIBERS, AND METHOD FOR MANUFACTURING RESIN FORMED BODY FOR PLASTIC OPTICAL FIBERS

(71) Applicant: NITTO DENKO CORPORATION, Osaka (JP)

(72) Inventor: Takashi Ozaki, Osaka (JP)

(73) Assignee: NITTO DENKO CORPORATION, Osaka (JP)

(21) Appl. No.: 18/899,699

(22) Filed: Sep. 27, 2024

(30) Foreign Application Priority Data
Oct. 2, 2023 (JP) 2023-171193

(51) Int. Cl. G02B 1/04; C08F 14/18; C08F 24/00; C08J 3/09

(52) U.S. Cl. CPC G02B 1/046; C08F 14/185; C08F 24/00; C08J 3/093; C08J 3/095; G02B 1/048

(57) ABSTRACT

A fluorine-containing resin composition of the present invention includes: a fluorine-containing resin; and a solvent in which the fluorine-containing resin is dissolved. The solvent is a perfluoroalkene. The fluorine-containing resin includes a fluorine-containing polymer including a structural unit (A) represented by the following formula (1).

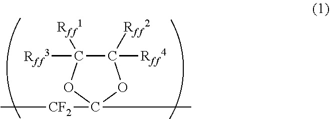

(In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² are optionally linked to form a ring.)

### BACKGROUND OF THE INVENTION

### 1. Field of the Invention

The present invention relates to a fluorine-containing resin composition for plastic optical fibers, a plastic optical fiber or a resin rod for plastic optical fibers, and a method for manufacturing a resin formed body for plastic optical fibers.

### 2. Description of Related Art

Fluorine-containing resins are used in various applications as resin materials used for photolithography techniques, materials of optical components such as plastic optical fibers (hereinafter referred to as “POFs”), and the like. When fluorine-containing resins are used in such applications, for example, compositions including the fluorine-containing resins dissolved in solvents are used. For example, in the case where a fluorine-containing resin is used for photolithography techniques as a material of an antireflection film formed on a photoresist layer, a composition including the fluorine-containing resin dissolved in a solvent is used as a composition for coating for antireflection film production. In the case where a fluorine-containing resin is used in optical applications, refinement for removing a foreign matter from the resin is required to reduce a quality reduction of an optical component by the foreign matter. In that case, a method in which a composition including the fluorine-containing resin dissolved in a solvent is produced and then filtered is commonly used to remove the foreign matter from the fluorine-containing resin. As just described, fluorine-containing resin compositions including a fluorine-containing resin and a solvent are used in various manners when fluorine-containing resins are used in various applications.

JP 7014987 B2 discloses a composition including a fluorine-containing polymer and an aprotic solvent, the composition including the fluorine-containing polymer at high concentration (specifically, 20 mass % or more). According to JP 7014987 B2, the aprotic solvent is a perfluoro aromatic compound, a perfluorotrialkylamine, a perfluoroalkane, a hydrofluorocarbon, a perfluorocyclic ether, a hydrofluoroether, or an olefin compound including at least one chlorine atom.

### SUMMARY OF THE INVENTION

Recently, compositions including a fluorine-containing resin are required to further lessen an environmental impact. Moreover, as described above, compositions including a fluorine-containing resin may be used in various processes according to applications. Compositions for optical components, particularly POFs, are required not to allow a material that is highly likely to be used as a process material to be eluted a lot into the compositions, i.e., not to allow a large amount of impurities to intrude into the compositions through a process, the compositions including a fluorine-containing resin.

The present invention aims to provide a new fluorine-containing resin composition for POFs, the new fluorine-containing resin composition being capable of lessening an environmental impact, the new fluorine-containing resin composition being capable of reducing intrusion of impurities through a process. Moreover, the present invention also aims to provide a POF including the new fluorine-containing resin composition for POFs or a resin rod for POFs, the resin rod including the new fluorine-containing resin composition for POFs. Furthermore, the present invention also aims to provide a method for manufacturing a resin formed body for POFs using a new fluorine-containing resin composition for POFs, the new fluorine-containing resin composition being capable of lessening an environmental impact, the new fluorine-containing resin composition being capable of reducing intrusion of impurities through a process.

A fluorine-containing resin composition for POFs according to a first aspect of the present invention includes:
a fluorine-containing resin; and
a solvent in which the fluorine-containing resin is dissolved, wherein
the solvent is a perfluoroalkene, and
the fluorine-containing resin includes a fluorine-containing polymer including a structural unit (A) represented by the following formula (1):

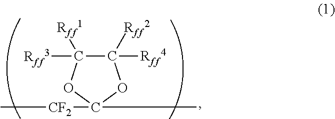

where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² are optionally linked to form a ring.

A fluorine-containing resin composition for POFs according to a second aspect of the present invention includes:
a fluorine-containing resin; and
a solvent in which the fluorine-containing resin is dissolved, wherein
the solvent is a perfluoroalkene, and
the fluorine-containing resin includes a fluorine-containing polymer including a structural unit (D) represented by the following formula (4):

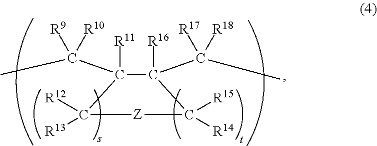

where Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms, one or some of the fluorine atoms are each optionally substituted by a halogen atom other than a fluorine atom, one or some of fluorine atoms in the perfluoroalkyl group are each optionally substituted by a halogen atom other than a fluorine atom, one or some of fluorine atoms in the perfluoroalkoxy group are each optionally substituted by a halogen atom other than a fluorine atom, s and t are each independently 0 to 5, and s+t is an integer of 1 to 6 or, in the case where Z is-OC(R¹⁹R²⁰)O—, s+t is optionally 0.

A POF or a resin rod for POFs according to a third aspect of the present invention includes the fluorine-containing resin composition for POFs according to the first or second aspect.

A method for manufacturing a resin formed body for POFs according to a fourth aspect of the present invention includes
(i) producing a resin formed body for POFs including the fluorine-containing resin using the fluorine-containing resin composition for POFs according to the first or second aspect.

The present invention can provide a new fluorine-containing resin composition for POFs, the new fluorine-containing resin composition being capable of lessening an environmental impact, the new fluorine-containing resin composition being capable of reducing intrusion of impurities through a process. Moreover, the present invention can provide a POF including the new fluorine-containing resin composition for POFs or a resin rod for POFs, the resin rod including the new fluorine-containing resin composition for POFs. Furthermore, the present invention can provide a method for manufacturing a resin formed body for POFs using a new fluorine-containing resin composition for POFs, the new fluorine-containing resin composition being capable of lessening an environmental impact, the new fluorine-containing resin composition being capable of reducing intrusion of impurities through a process.

### BRIEF DESCRIPTION OF THE DRAWING

FIG. 1 is a flowchart showing an example of a method for manufacturing a resin formed body for POFs according to Embodiment 2.

FIG. 2 is a cross-sectional view showing an example of a POF manufactured by the method for manufacturing a resin formed body for POFs according to Embodiment 2.

### DETAILED DESCRIPTION OF THE INVENTION

### Embodiment 1

An embodiment of a fluorine-containing resin composition for POFs according to the present invention will be described.

A fluorine-containing resin composition for POFs according to the present embodiment includes: a fluorine-containing resin; and a solvent in which the fluorine-containing resin is dissolved. The solvent includes a perfluoroalkene. Here, “perfluoro” indicates that every hydrogen atom bonded to a carbon atom is substituted by a fluorine atom. Fluorine-containing resin compositions for POFs are hereinafter simply referred to as fluorine-containing resin compositions.

In the fluorine-containing resin composition according to the present embodiment, the perfluoroalkene is included as the solvent. The perfluoroalkene has a lower global warming potential (hereinafter may be referred to as “GWP”) than those of fluorine-containing solvents, such as a hydrofluorocarbon, a hydrofluoroether, and a perfluoroalkane, included in conventional fluorine-containing resin compositions as solvents. The perfluoroalkene can have, for example, a GWP less than 150, less than 100, less than 50, or less than 10. Additionally, the perfluoroalkene has a low ozone depletion potential (hereinafter may be referred to as “ODP”), namely, zero ODP, as do conventional fluorine-containing solvents as listed above. Hence, the fluorine-containing resin composition according to the present embodiment including, as its solvent, the perfluoroalkene whose GWP is lower than those of conventional fluorine-containing solvents and whose ODP is zero can lessen an environmental impact relative to conventional fluorine-containing resin compositions.

The GWP is an index to estimate a relative impact imposed on global warming by 1 kg of a particular greenhouse gas discharged into the air relative to 1 kg of carbon dioxide discharged. The GWP of a gas can be calculated over different time ranges, and reflects an atmospheric lifetime of the gas. A GWP over a time range of 100 years is commonly a value to be referred to.

One of the reasons why the perfluoroalkene can have a low GWP is thought to be due to the fact that the perfluoroalkene has no C—H bond. Since having no C—H bond, the perfluoroalkene has a poor capability of absorbing infrared light and therefore absorbs a small amount of infrared light. Therefore, it is thought that the perfluoroalkene can have a lower GWP than that of a fluorine-containing solvent having a C—H bond. Another possible reason why the perfluoroalkene can have a low GWP is its short atmospheric lifetime. The perfluoroalkene has a double bond and thus has a high OH radical reactivity. Therefore, it is thought that the perfluoroalkene can have a lower GWP than that of a fluorine-containing solvent having no double bond. Because the GWP depends not only on the infrared absorption amount and the atmospheric lifetime but on various factors, it is thought to be difficult to determine a magnitude relation of GWPs from the infrared absorption amount only or the atmospheric lifetime only. However, since both the infrared absorption amount and the atmospheric lifetime of the perfluoroalkene are superior to those of conventional fluorine-containing solvents, it is thought that the perfluoroalkene can have a lower GWP than those of conventional fluorine-containing solvents.

Moreover, the perfluoroalkene does not include a proton in its skeletal structure. Because of this, when used in various processes according to its applications, the fluorine-containing resin composition according to the present embodiment does not allow a material used as a process material to be eluted a lot. That is, the fluorine-containing resin composition according to the present embodiment can reduce intrusion of impurities through a process. Examples of the material used as a process material include resin materials and metal materials.

As described above, the fluorine-containing resin composition according to the present embodiment can lessen an environmental impact and can reduce intrusion of impurities through a process.

In the fluorine-containing resin composition according to the present embodiment, the solvent preferably includes the perfluoroalkene as its main component. In this case, the fluorine-containing resin composition according to the present embodiment can further lessen an environmental impact and can further reduce intrusion of impurities through a process. Saying that the solvent includes the perfluoroalkene as its main component herein means that a component whose content is highest in mass in the solvent included in the fluorine-containing resin composition according to the present embodiment is the perfluoroalkene. Note that when a plurality of perfluoroalkenes are included in the solvent, the mass of the perfluoroalkene in the solvent is the total mass of the plurality of perfluoroalkenes.

To further lessen an environmental impact and reduce intrusion of impurities, the solvent of the fluorine-containing resin composition according to the present embodiment may substantially consist of the perfluoroalkene. Saying that the solvent substantially consists of the perfluoroalkene herein means that the perfluoroalkene content in the solvent is 90 mass % or more and is preferably 95 mass % or more. Note that when a plurality of perfluoroalkenes are included in the solvent, the perfluoroalkene content in the solvent is determined from the total mass of the plurality of perfluoroalkenes. In the fluorine-containing resin composition according to the present embodiment, the solvent may consist of the perfluoroalkene.

A degree of solubility and a dissolution speed of the fluorine-containing resin in the perfluoroalkene are higher than those of conventional fluorine-containing solvents. Hence, owing to the perfluoroalkene included as the solvent, the fluorine-containing resin composition according to the present embodiment can enhance the solubility of the fluorine-containing resin in the solvent.

Moreover, the fluorine-containing resin composition according to the present embodiment has excellent filterability. Therefore, the fluorine-containing resin composition according to the present embodiment can be filtered efficiently, for example, when filtered for refinement to give a resin material including the fluorine-containing resin. Saying that the fluorine-containing resin composition has excellent filterability means that the viscosity of the fluorine-containing resin composition is not likely to increase with increasing concentration of the fluorine-containing resin, that the fluorine-containing resin composition can have a lower viscosity than another fluorine-containing resin composition having the same fluorine-containing resin concentration, and that the fluorine-containing resin composition passes through a filter without difficulty at the time of filtration. To achieve excellent filterability, for example, a solution viscosity of the fluorine-containing resin composition according to the present embodiment at 25° C. is preferably 1 mPa·s or more and less than 110 mPa·s, more preferably 1 mPa·s or more and 100 mPa·s or less, even more preferably 1 mPa·s or more and 90 mPa·s or less, particularly preferably 1 mPa·s or more and 50 mPa·s or less, most preferably 1 mPa·s or more and 15 mPa·s or less. The solution viscosity is measured according to JIS K 7117-2 using an E-type viscometer.

In the fluorine-containing resin composition according to the present embodiment, the concentration of the fluorine-containing resin is determined as appropriate according to an application of the fluorine-containing resin composition and is thus not limited to a particular value. However, in the case where the fluorine-containing resin composition according to the present embodiment is filtered, the concentration of the fluorine-containing resin in the fluorine-containing resin composition according to the present embodiment is preferably 1 mass % or more and less than 20 mass %, more preferably 1 mass % or more and 19.5 mass % or less, even more preferably 1 mass % or more and 15 mass % or less, particularly preferably 1 mass % or more and 12 mass % or less, most preferably 1 mass % or more and 8 mass % or less for better filterability.

The fluorine-containing resin of the fluorine-containing resin composition according to the present embodiment and the perfluoroalkene thereof used as the solvent will be hereinafter described in more details.

### [Fluorine-Containing Resin]

The fluorine-containing resin includes a fluorine-containing polymer. Since the fluorine-containing resin composition according to the present embodiment is for POFs, it is preferred that the fluorine-containing polymer included in the fluorine-containing resin be substantially free of a hydrogen atom to reduce light absorption attributable to stretching energy of a C—H bond. It is particularly preferred that every hydrogen atom bonded to a carbon atom be substituted by a fluorine atom. That is, it is preferred that the fluorine-containing polymer be substantially free of a hydrogen atom and be fully fluorinated. Herein, saying that the fluorine-containing polymer is substantially free of a hydrogen atom means that the hydrogen atom content in the fluorine-containing polymer is 1 mol % or less.

The fluorine-containing polymer preferably has a fluorine-containing aliphatic ring structure. The fluorine-containing aliphatic ring structure may be included in a main chain of the fluorine-containing polymer, or may be included in a side chain of the fluorine-containing polymer.

One example of the fluorine-containing polymer (hereinafter referred to as “first example of the fluorine-containing polymer”) includes, for example, a structural unit (A) represented by the following structural formula (1).

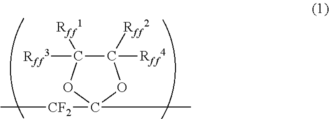

In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² are optionally linked to form a ring. “Perfluoro” indicates that every hydrogen atom bonded to a carbon atom is substituted by a fluorine atom. In the formula (1), the number of carbon atoms in the perfluoroalkyl group is preferably 1 to 5, more preferably 1 to 3, and even more preferably 1. The perfluoroalkyl group may be linear or branched. Examples of the perfluoroalkyl group include a trifluoromethyl group, a pentafluoroethyl group, and a heptafluoropropyl group.

In the formula (1), the number of carbon atoms in the perfluoroalkyl ether group is preferably 1 to 5 and more preferably 1 to 3. The perfluoroalkyl ether group may be linear or branched. Examples of the perfluoroalkyl ether group include a perfluoromethoxymethyl group.

In the case where R_{ff}¹ and R_{ff}² are linked to form a ring, the ring may be a five-membered ring or a six-membered ring. Examples of the ring include a perfluorotetrahydrofuran ring, a perfluorocyclopentane ring, and a perfluorocyclohexane ring.

Specific examples of the structural unit (A) include structural units represented by the following formulae (A1) to (A8).

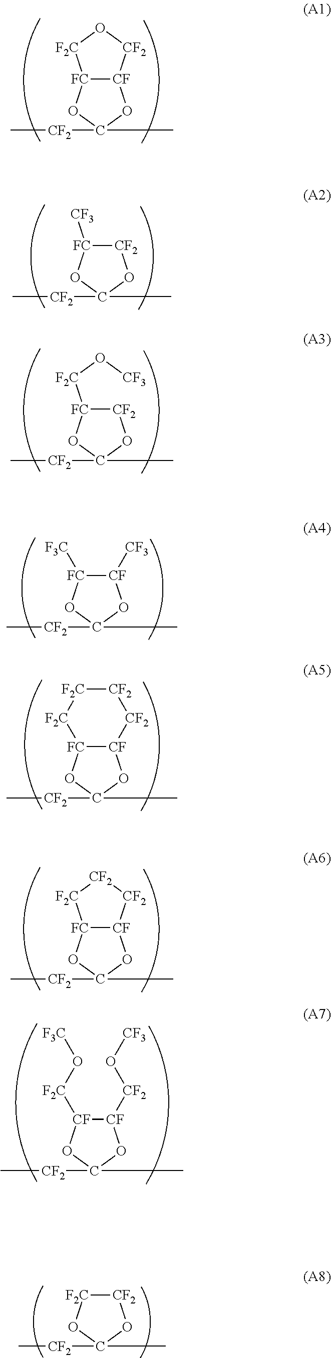

Among the structural units represented by the above formulae (A1) to (A8), the structural unit (A) is preferably the structural unit (A2), i.e., a structural unit represented by the following formula (5).

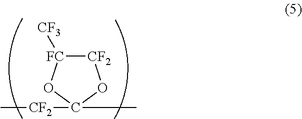

The first example of the fluorine-containing polymer may include one or more structural units (A). In the first example of the fluorine-containing polymer, the amount of the structural unit (A) may be 20 mol % or more, or 40 mol % or more of a total amount of all structural units. When the structural unit (A) accounts for 20 mol % or more of the first example of the fluorine-containing polymer, the fluorine-containing polymer tends to have much higher thermal resistance. When the structural unit (A) accounts for 40 mol % or more of the first example of the fluorine-containing polymer, the fluorine-containing polymer tends to have much higher transparency and much higher mechanical strength in addition to high thermal resistance. In the first example of the fluorine-containing polymer, the amount of the structural unit (A) may be 95 mol % or less, or 70 mol % or less of the total amount of all structural units.

The structural unit (A) is derived from, for example, a compound represented by the following formula (6). In the formula (6), R_{ff}¹ to R_{ff}⁴ are as described in the formula (1). It should be noted that the compound represented by the formula (6) can be obtained, for example, by an already-known manufacturing method such as a manufacturing method disclosed in JP 2007-504125 A.

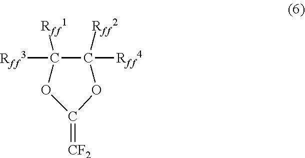

Specific examples of the compound represented by the above formula (6) include compounds represented by the following formulae (M1) to (M8).

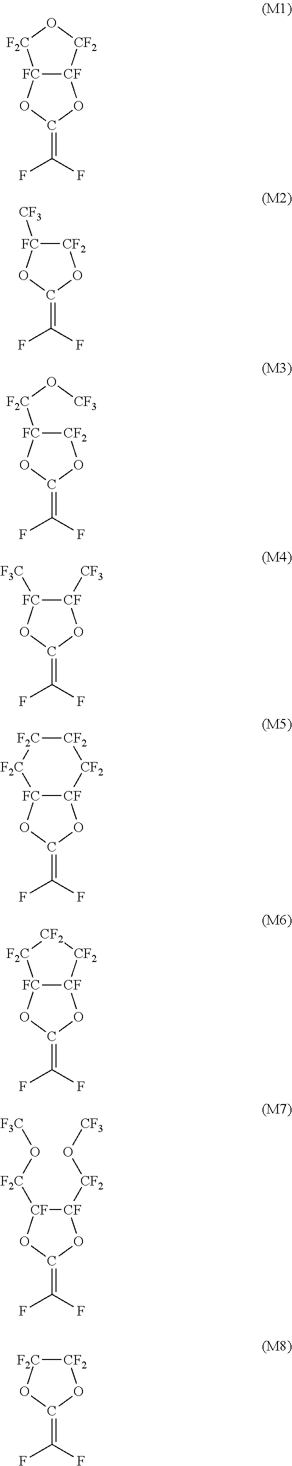

The first example of the fluorine-containing polymer may further include an additional structural unit other than the structural unit (A). Examples of the additional structural unit include the following structural units (B) to (D). That is, the fluorine-containing polymer including the structural unit (A) may further include at least one selected from the group consisting of a structural unit (B) represented by the following formula (2), a structural unit (C) represented by the following formula (3), and a structural unit (D) represented by the following formula (4).

The structural unit (B) is represented by the following formula (2).

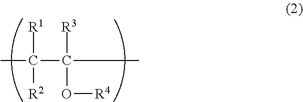

In the formula (2), R¹ to R³ each independently represent a fluorine atom or a perfluoroalkyl group having 1 to 7 carbon atoms. R⁴ represents a perfluoroalkyl group having 1 to 7 carbon atoms. The perfluoroalkyl group may have a ring structure. One or some of the fluorine atoms are each optionally substituted by a halogen atom other than a fluorine atom. One or some of fluorine atoms in the perfluoroalkyl group are each optionally substituted by a halogen atom other than a fluorine atom.

The first example of the fluorine-containing polymer may include one or more structural units (B). In the first example of the fluorine-containing polymer, the amount of the structural unit (B) is preferably 5 to 10 mol % of the total amount of all structural units. The amount of the structural unit (B) may be 9 mol % or less or 8 mol % or less.

The structural unit (B) is derived from, for example, a compound represented by the following formula (7). In the formula (7), R¹ to R⁴ are as described for the formula (2). The compound represented by the formula (7) is a fluorine-containing vinyl ether such as perfluorovinyl ether.

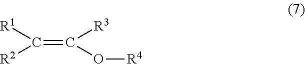

The structural unit (C) is represented by the following formula (3).

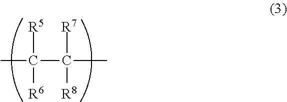

In the formula (3), R⁵ to R⁸ each independently represent a fluorine atom or a perfluoroalkyl group having 1 to 7 carbon atoms. The perfluoroalkyl group may have a ring structure. One or some of the fluorine atoms are each optionally substituted by a halogen atom other than a fluorine atom. One or some of fluorine atoms in the perfluoroalkyl group are each optionally substituted by a halogen atom other than a fluorine atom.

The first example of the fluorine-containing polymer may include one or more structural units (C). In the first example of the fluorine-containing polymer, the amount of the structural unit (C) is preferably 5 to 10 mol % of the total amount of all structural units. The amount of the structural unit (C) may be 9 mol % or less or 8 mol % or less.

The structural unit (C) is derived from, for example, a compound represented by the following formula (8). In the formula (8), R⁵ to R⁸ are as described for the formula (3). The compound represented by the formula (8) is a fluorine-containing olefin such as tetrafluoroethylene or chlorotrifluoroethylene.

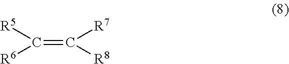

The structural unit (D) is represented by the following formula (4).

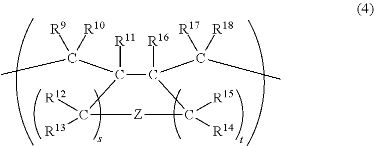

In the formula (4), Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms. One or some of the fluorine atoms are each optionally substituted by a halogen atom other than a fluorine atom. One or some of fluorine atoms in the perfluoroalkyl group are each optionally substituted by a halogen atom other than a fluorine atom. One or some of fluorine atoms in the perfluoroalkoxy group may be substituted by a halogen atom other than a fluorine atom. Symbols s and t are each independently 0 to 5, and s+t is an integer of 1 to 6 or, in the case where Z is-OC(R¹⁹R²⁰)O—, s+t is optionally 0.

The structural unit (D) is preferably represented by the following formula (9). The structural unit represented by the following formula (9) is a structural unit represented by the above formula (4), where Z is an oxygen atom, s is 0, and t is 2.

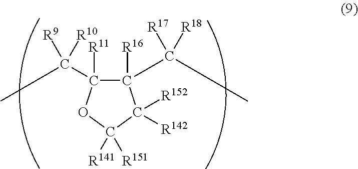

In the formula (9), R¹⁴¹, R¹⁴², R¹⁵¹, and R¹⁵² are each independently a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom.

The first example of the fluorine-containing polymer may include one or more structural units (D). In the first example of the fluorine-containing polymer, the amount of the structural unit (D) is preferably 30 to 67 mol % of the total amount of all structural units. The amount of the structural unit (D) is, for example, 35 mol % or more, and may be 60 mol % or less or 55 mol % or less.

The structural unit (D) is derived from, for example, a compound represented by the following formula (10). In the formula (10), Z, R⁹ to R¹⁸, s, and t are as described for the formula (4). The compound represented by the formula (10) is a cyclopolymerizable fluorine-containing compound having two or more polymerizable double bonds.

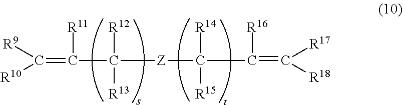

The structural unit (D) is preferably derived from a compound represented by the following formula (11). In the formula (11), R¹⁴¹, R¹⁴², R¹⁵¹, and R¹⁵² are as described for the formula (9).

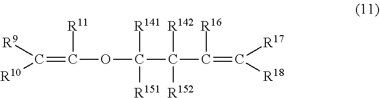

Specific examples of the compound represented by the formula (10) or the formula (11) include the following compounds.
CF₂═CFOCF₂CF═CF₂
CF₂═CFOCF(CF₃)CF═CF₂
CF₂═CFOCF₂CF₂CF═CF₂
CF₂═CFOCF₂CF(CF₃)CF═CF₂
CF₂═CFOCF(CF₃)CF₂CF═CF₂
CF₂═CFOCFClCF₂CF═CF₂
CF₂=CFOCCl₂CF₂CF═CF₂
CF₂═CFOCF₂OCF═CF₂
CF₂=CFOC(CF₃)₂OCF═CF₂
CF₂═CFOCF₂CF(OCF₃)CF═CF₂
CF₂═CFCF₂CF═CF₂
CF₂═CFCF₂CF₂CF═CF₂
CF₂═CFCF₂OCF₂CF═CF₂
CF₂═CFOCF₂CFClCF═CF₂
CF₂═CFOCF₂CF₂CCl=CF₂
CF₂═CFOCF₂CF₂CF═CFCl
CF₂═CFOCF₂CF(CF₃) CCl=CF₂
CF₂═CFOCF₂OCF═CF₂
CF₂=CFOCCl₂OCF═CF₂
CF₂=CClOCF₂OCCl=CF₂

The first example of the fluorine-containing polymer may further include an additional structural unit other than the structural units (A) to (D). However, the first example of the fluorine-containing polymer is preferably substantially free of an additional structural unit other than the structural units (A) to (D). Saying that the first example of the fluorine-containing polymer is substantially free of an additional structural unit other than the structural units (A) to (D) means that the sum of the amounts of the structural units (A) to (D) is 95 mol % or more and preferably 98 mol % or more of the total amount of all structural units in the fluorine-containing polymer.

The fluorine-containing polymer included in the fluorine-containing resin may be an example (hereinafter referred to as “second example of the fluorine-containing polymer”) different from the above first example of the fluorine-containing polymer. The second example of the fluorine-containing polymer includes the above structural unit (D). The second example of the fluorine-containing polymer may be composed only of the structural unit (D), or may further include an additional structural unit other than the structural unit (D). The second example of the fluorine-containing polymer may include one or more structural units (D).

The method for polymerizing the above first and second examples of the fluorine-containing polymer is not limited to a particular one, and a common polymerization method such as radical polymerization can be used. A polymerization initiator for polymerization of the fluorine-containing polymer may be a fully fluorinated compound.

### [Perfluoroalkene]

In the fluorine-containing resin composition according to the present embodiment, the perfluoroalkene used as the solvent has, for example, 2 to 10 carbon atoms. The perfluoroalkene having 2 to 10 carbon atoms has a low boiling point, and thus volatilization of the solvent is easy. Here, “2 to 10” means 2 or more and 10 or less.

The perfluoroalkene may be a chain perfluoroalkene or a cyclic perfluoroalkene. The chain perfluoroalkene may be a linear perfluoroalkene or a branched perfluoroalkene.

The perfluoroalkene may be, for example, a chain perfluoroalkene represented by formula (12): CₙF₂ₙ, where n is an integer of 2 or more. In the formula (12), n is, for example, 10 or less, and preferably 8 or less.

The perfluoroalkene may be a perfluoroalkene represented by formula (13): R²¹CF═CFR²². In the formula (13), R²¹ and R²² are each independently a perfluoroalkyl group having 1 to 6 carbon atoms. The above alkene may be cis (which may be represented by (Z)) or trans (which may be represented by (E)).

The perfluoroalkene is represented by, for example, formula (14) or (15). Formula (14): a perfluoroalkene represented by (E)-R²³CF═CFR²⁴ or (Z)—R²³CF═CFR²⁴, where R²³ and R²⁴ are each independently a F atom or a perfluoroalkyl group having 1 to 8 carbon atoms, and the total number of carbon atoms in the compound is at least 4.

Formula (15): a perfluorocycloalkene represented by cyclo-[CF═CF(CF₂)ₙ—], where n is an integer of 2 to 6.

Examples of the perfluoroalkene include 1,1,1,2,3,4,4,4-octafluoro-2-butene (CF₃CF═CFCF₃); 1,1,2,3,3,4,4,4-octafluoro-1-butene (CF₃CF₂CF═CF₂); 1, 1,1,2,3,4,4,5,5,5-decafluoro-2-pentene (CF₃CF═CFCF₂CF₃); 1,1,2,3,3,4,4,5,5,5-decafluoro-1-pentene (CF₂═CFCF₂CF₂CF₃); 1,1,2,3,3,4,4,5,5,6,6,6-dodecafluoro-1-hexene (CF₃ (CF₂)₃CF═CF₂); 1, 1,1,2,2,3,4,5,5,6,6,6-dodecafluoro-3-hexene (CF₃CF₂CF═CFCF₂CF₃); 1,1,1,4,4,4-hexafluoro-2,3-bis(trifluoromethyl)-2-butene ((CF₃)₂C═C(CF₃)₂); 1,1,1,2,3,4,5,5,5-nonafluoro-4-(trifluoromethyl)-2-pentene ((CF₃)₂CFCF═CFCF₃); 1,1,1,2,3,4,4,5,5,6,6,7,7,7-tetradecafluoro-2-heptene (CF₃CF═CFCF₂CF₂C₂F₅); 1,1,1,2,2,3,4,5,5,6,6,7,7,7-tetradecafluoro-3-heptene (CF₃CF₂CF═CFCF₂C₂F₅); 1,1,2,3,3,4,4,5,5,6,6,7,7,7-tetradecafluoro-1-heptene (CF₂═CFCF₂CF₂CF₂C₂F₅); 1,1,2,3,3,4,4,5,5,6,6,7,7,8,8,8-hexadecafluoro-1-octene (CF₂═CFCF₂CF₂CF₂CF₂C₂F₅); 1,1,2,3,3,4,4,5,5,6,6,7,7,8,8,9,9,9-octadecafluoro-1-nonene (CF₂═CFCF₂CF₂CF₂CF₂CF₂C₂F₅); 1,1,2,3,3,4,4,5,5,6,6,7,7,8,8,9,9,10,10,10-eicosafluoro-1-decene (CF₂═CFCF₂CF₂CF₂CF₂CF₂CF₂C₂F₅); and 1,2,3,3,4,4,5,5,6,6-decafluorocyclohexene (cyclo-[CF═CF(CF₂)₄—]). In the present embodiment, the perfluoroalkene may include at least one selected from the compounds shown above as examples. The above compounds may be cis (Z) or trans (E).

In the fluorine-containing resin composition according to the present embodiment, the perfluoroalkene may include 1,1,1,2,2,3,4,5,5,6,6,7,7,7-tetradecafluoro-3-heptene (CF₃CF₂CF═CFCF₂C₂F₅). The GWP of 1,1,1,2,2,3,4,5,5,6,6,7,7,7-tetradecafluoro-3-heptene is less than 10, which is very low. Hence, in this case, the fluorine-containing resin composition according to the present embodiment can even further lessen an environmental impact. Additionally, 1,1,1,2,2,3,4,5,5,6,6,7,7,7-tetradecafluoro-3-heptene is not likely to allow a material used as a process material to be eluted and can even further reduce the amount of the process material eluted. Hence, in this case, the fluorine-containing resin composition according to the present embodiment can even further reduce intrusion of impurities through a process.

The degree of solubility and the dissolution speed of the fluorine-containing resin in 1,1,1,2,2,3,4,5,5,6,6,7,7,7-tetradecafluoro-3-heptene are very high, compared to those of conventional fluorine-containing solvents. Hence, when 1,1,1,2,2,3,4,5,5,6,6,7,7,7-tetradecafluoro-3-heptene is included as the solvent, the fluorine-containing resin composition according to the present embodiment can even further enhance the solubility of the fluorine-containing resin in the solvent.

Additionally, the fluorine-containing resin composition including 1,1,1,2,2,3,4,5,5,6,6,7,7,7-tetradecafluoro-3-heptene as the solvent has more excellent filterability. Therefore, when 1,1,1,2,2,3,4,5,5,6,6,7,7,7-tetradecafluoro-3-heptene is included as the solvent, the fluorine-containing resin composition according to the present embodiment can be filtered more efficiently.

The perfluoroalkene may include 1,1,1,2,2,3,4,5,5,6,6,7,7,7-tetradecafluoro-3-heptene as its main component. Saying that the perfluoroalkene includes 1,1,1,2,2,3,4,5,5,6,6,7,7,7-tetradecafluoro-3-heptene as its main component means that a component whose content is highest in mass in the perfluoroalkene is 1,1,1,2,2,3,4,5,5,6,6,7,7,7-tetradecafluoro-3-heptene.

In the fluorine-containing resin composition according to the present embodiment, the perfluoroalkene may substantially consist of 1,1,1,2,2,3,4,5,5,6,6,7,7,7-tetradecafluoro-3-heptene. Saying that the perfluoroalkene substantially consists of 1, 1,1,2,2,3,4,5,5,6,6,7,7,7-tetradecafluoro-3-heptene herein means that the 1,1,1,2,2,3,4,5,5,6,6,7,7,7-tetradecafluoro-3-heptene content in the perfluoroalkene is 90 mass % or more and is preferably 95 mass % or more. In the fluorine-containing resin composition according to the present embodiment, the perfluoroalkene included as the solvent may consist of 1,1,1,2,2,3,4,5,5,6,6,7,7,7-tetradecafluoro-3-heptene.

### [Additional Components]

The fluorine-containing resin composition according to the present embodiment may further include an additional component other than the above fluorine-containing resin and the above solvent including the perfluoroalkene. The fluorine-containing resin composition according to the present embodiment may include, for example, an additive such as a refractive index modifier.

### Embodiment 2

An embodiment of a method for manufacturing a resin formed body for POFs according to the present invention will be described.

The method for manufacturing a resin formed body for POFs according to the present embodiment includes
(i) producing a resin formed body for POFs using the fluorine-containing resin composition of Embodiment 1, the resin formed body including a fluorine-containing resin.

The fluorine-containing resin composition is as described in Embodiment 1, and thus a detailed description thereof is omitted here.

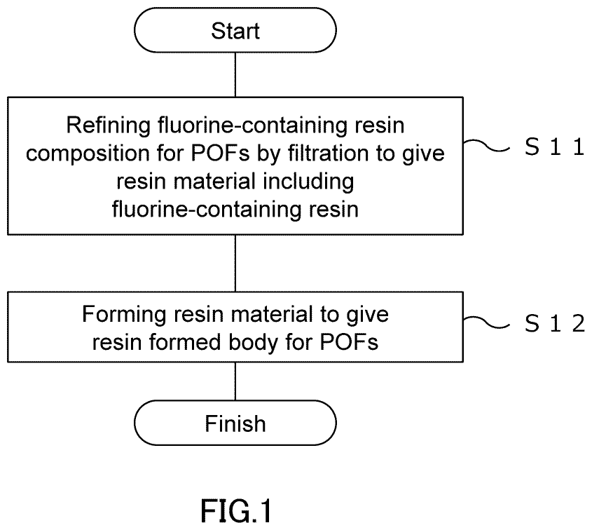

In the step (i), the fluorine-containing resin composition may be subjected, for example, to refinement to give a resin material for forming the resin formed body for POFs. FIG. 1 shows a flowchart of the manufacturing method of this case. In this case, for example, in the step (i) of the manufacturing method according to the present embodiment, the fluorine-containing resin composition is refined by filtration to give a resin material including the fluorine-containing resin composition (S11) and the resin material is formed to give the resin formed body for POFs (S12). As described in Embodiment 1, the fluorine-containing resin composition has excellent filterability. Therefore, according to the manufacturing method of the present embodiment, the fluorine-containing resin composition can be filtered efficiently when filtered for refinement to give a resin material including the fluorine-containing resin. Thus, a high-quality foreign-matter-free resin formed body for POFs can be manufactured efficiently by the manufacturing method according to the present embodiment.

In the manufacturing method according to the present embodiment, the method in which the fluorine-containing resin composition is used for production of a resin formed body for POFs is not limited to the above filtration for refinement.

A very small amount of the perfluoroalkene included in the fluorine-containing resin composition as the solvent may detectably remain in a resin formed body for POFs, the resin formed body being obtained by the manufacturing method according to the present embodiment. A technique for detecting the perfluoroalkene in the resin formed body for POFs is, for example, gas chromatography (GC).

According to the manufacturing method of the present embodiment, for example, as shown in the flowchart of FIG. 1, the fluorine-containing resin composition is refined by filtration to give the resin material including the fluorine-containing resin (S11), and the resin material is formed to give a resin formed body for POFs (S12). Here, the resin formed body for POFs may be a POF itself. That is, in S12, a POF can be manufactured by forming the resin material into a fiber shape. The POF manufactured thereby may be, for example, a graded-index POF in which a refractive index distribution of the core is symmetric with respect to the central axis. The resin material obtained by the refinement and including the fluorine-containing resin may be used as a core material or a cladding material of a POF.

A specific method for forming the resin material into a fiber shape to give a POF is not limited to a particular method. For example, a POF can be produced by melting the resin material obtained by the refinement in S11 by heating at a temperature equal to or higher than the glass transition temperature of the resin material, for example, by 50° C. and spinning the molten resin material by melt extrusion to be formed into a fiber shape. It should be noted that the core of a graded-index POF in which the refractive index of the core is symmetric with respect to the central axis can be produced by diffusing a refractive index modifier inside the resin material by heating at the time of the spinning by melt extrusion.

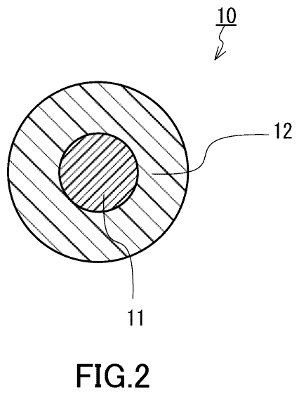

FIG. 2 is a cross-sectional view of an example of a POF that can be manufactured by the manufacturing method according to the present embodiment. A POF 10 that can be manufactured by the manufacturing method according to the present embodiment includes, for example, a core 11 and a cladding 12 disposed on an outer circumference of the core 11. The core 11 can be obtained, for example, by spinning a resin material (core material) by melt extrusion to form the resin material into a fiber shape, the resin material being obtained by filtering the fluorine-containing resin composition, the resin material including the fluorine-containing resin. The cladding 12 can be formed, for example, by melt-extruding a resin material (cladding material) to coat the outer circumference of the core 11, the resin material being obtained by filtering the fluorine-containing resin composition, the resin material including the fluorine-containing resin. The core 11 of a graded-index POF in which the refractive index of the core 11 is symmetric with respect to the central axis can be produced by diffusing a refractive index modifier included in the core material inside the resin material by heating at the time of the spinning by melt extrusion. When the fluorine-containing resin composition of Embodiment 1 is used to prepare the core material and the cladding material, the resulting core 11 and the resulting cladding 12 can sometimes include the perfluoroalkene in such a very small amount that the perfluoroalkene does not affect the performance of the core and the cladding.

### Embodiment 3

An embodiment of a POF of the present invention or a resin rod for POFs of the present invention will be described.

A POF or a resin rod for POFs according to the present embodiment includes the fluorine-containing resin composition of Embodiment 1. The resin rod for POFs is used for manufacturing of a POF by melt extrusion. A POF can be produced, for example, by melting the resin rod for POFs by heating and spinning the molten resin rod by melt extrusion to be formed into a fiber shape. The POF or the resin rod for POFs according to the present embodiment can include the solvent including the perfluoroalkene. The perfluoroalkene included in the solvent can be detected by gas chromatography (GC).

### EXAMPLES

Hereinafter, the present invention will be described in more detail by way of Examples and Comparative Examples. The present invention is not limited to these.

### Example 1

### [Production of Fluorine-Containing Resin]

A polymer of perfluoro-4-methyl-2-methylene-1,3-dioxolane (a compound represented by the above formula (M2); PFMMD) was prepared as a fluorine-containing resin. The perfluoro-4-methyl-2-methylene-1,3-dioxolane was synthesized by synthesizing 2-carbomethyl-2-trifluoromethyl-4-methyl-1,3-dioxolane, fluorinating the 2-carbomethyl-2-trifluoromethyl-4-methyl-1,3-dioxolane, and then decarboxylating the resulting carboxylic acid salt. In the polymerization of the perfluoro-4-methyl-2-methylene-1,3-dioxolane, perfluorobenzoyl peroxide was used as a polymerization initiator.

The synthesis of 2-carbomethyl-2-trifluoromethyl-4-methyl-1,3-dioxolane, the fluorination of 2-carbomethyl-2-trifluoromethyl-4-methyl-1,3-dioxolane, the synthesis of perfluoro-4-methyl-2-methylene-1,3-dioxolane, and the polymerization of perfluoro-4-methyl-2-methylene-1,3-dioxolane will be described hereinafter in details.

### Synthesis of 2-carbomethyl-2-trifluoromethyl-4-methyl-1,3-dioxolane

A 3 L three-neck flask equipped with a water-cooled chiller, a thermometer, a magnetic stirrer, and a pressure equalizing dropping funnel were prepared. An amount of 139.4 g (1.4 mols in total) of a mixture of 2-chloro-1-propanol and 1-chloro-2-propanol was put in the flask. The flask was cooled to 0° C., methyl trifluoropyruvate was slowly added thereto, and the contents were stirred for two hours. An amount of 100 mL of dimethyl sulfoxide (DMSO) and 194 g of potassium carbonate were added thereto over one hour followed by eight-hour stirring to obtain a reaction mixture. The reaction mixture generated was mixed with 1 L of water, and an aqueous phase of the resulting mixture was separated out. After extraction was performed with dichloromethylene, the dichloromethylene solution was mixed with an organic reaction mixture phase. The resulting solution was dried with magnesium sulfate. After the removal of the solvent, 245.5 g of an unrefined product was obtained. This unrefined product was fractionated under a reduced pressure (12 Torr) to obtain 230.9 g of a refined product, 2-carbomethyl-2-trifluoromethyl-4-methyl-1,3-dioxolane. The boiling point of the refined product was 77 to 78° C., and the percentage yield was 77%. HNMR (manufactured by Bruker Corporation; product name: Biospin, AVANCE III-600 with a cryo probe) and ¹⁹F NMR (manufactured by Bruker Corporation; product name: Biospin, AVANCE III-400) were used to confirm that the obtained refined product was 2-carbomethyl-2-trifluoromethyl-4-methyl-1,3-dioxolane.

HNMR (ppm): 4.2 to 4.6, 3.8 to 3.6 (CHCH₂, multiplet, 3H), 3.85 to 3.88 (COOCH₃, multiplet, 3H), 1.36 to 1.43 (CCH₃, multiplet, 3H)

¹⁹F NMR (ppm): −81.3 (CF₃, s, 3F)

### Fluorination of 2-carbomethyl-2-trifluoromethyl-4-methyl-1,3-dioxolane

An amount of 4 L of 1,1,2-trichlorotrifluoroethane was introduced into a 10 L stirred reaction vessel. In the stirred reaction vessel, nitrogen and fluorine were allowed to flow at a flow rate of 1340 cc/min and 580 cc/min, respectively, to create a nitrogen-fluorine atmosphere. Five minutes later, 290 g of the 2-carbomethyl-2-trifluoromethyl-4-methyl-1,3-dioxolane prepared beforehand was dissolved in 750 ml of a 1,1,2-trichlorotrifluoroethane solution. The resulting solution was added into the reaction vessel at 0.5 ml/min. The reaction vessel was cooled to 0° C. After the dioxolan was all added over 24 hours, the fluorine gas flow was stopped. The nitrogen gas was purged, and subsequently an aqueous potassium hydroxide solution was added until the mixture became weak alkaline.

After a volatile substance was removed under a reduced pressure, the reaction vessel was cooled. The cooling was followed by a 48-hour drying under a reduced pressure at 70° C. to obtain a solid reaction product. The solid reaction product was dissolved in 500 ml of water, to which an excessive amount of hydrochloric acid was added to separate the mixture into an organic phase and an aqueous phase. The organic phase was separated and distilled under a reduced pressure to obtain perfluoro-2,4-dimethyl-1,3-dioxolane-2-carboxylic acid. The boiling point of the main distillate was 103° C.-106° C./100 mmHg. The percentage yield of the fluorination was 85%.

### Synthesis of perfluoro-4-methyl-2-methylene-1,3-dioxolane

The above distillate was neutralized with an aqueous potassium hydroxide solution to obtain perfluoro-2,4-dimethyl-2-potassium carboxylate-1,3-dioxolane. This potassium salt was vacuum-dried at 70° C. for one day. The salt was decomposed at 250° C. to 280° C. under a nitrogen or argon atmosphere. Through condensation in a cold trap cooled at −78° C., perfluoro-4-methyl-2-methylene-1,3-dioxolane was obtained at a percentage yield of 82%. The boiling point of the product was 45° C./760 mmHg. The product was identified by 19F NMR (manufactured by Bruker Corporation; product name: Biospin, AVANCE III-400) and GC-MS (manufactured by Agilent Technologies; product name: 6890 plus/5973N).

¹⁹F NMR: −84 ppm (3F, CF₃), −129 ppm (2F, ═CF₂)

GC-MS: m/e244 (Molecular ion) 225, 197, 169, 150, 131, 100, 75, 50.

### Polymerization of perfluoro-4-methyl-2-methylene-1,3-dioxolane

An amount of 100 g of the perfluoro-4-methyl-2-methylene-1,3-dioxolane obtained in the above manner and 1 g of perfluorobenzoyl peroxide were put in a glass tube, which was then sealed. After oxygen in the system was removed by freeze-pump-thaw cycling, the glass tube was charged with argon and then heated at 50° C. for several hours. The contents thereby turned solids, which were further heated at 70° C. overnight to obtain 100 g of a transparent stick.

The transparent stick obtained was dissolved in Fluorinert FC-75 (manufactured by Sumitomo 3M Ltd.), and the resulting solution was poured onto a glass sheet to obtain a thin polymer film. The polymer had a glass transition temperature of 117° C., and was completely amorphous. The transparent stick was dissolved in a hexafluorobenzene solution, to which chloroform was added for precipitation. The product was thereby refined. A polymer resulting from the refinement had a glass transition temperature of approximately 131° C. This polymer was used as the fluorine-containing resin.

### [Production of Fluorine-Containing Resin Composition]

The fluorine-containing resin produced by the above method and a perfluoroalkene solvent were mixed in a glass screw tube. The perfluoroalkene used as a solvent was 1,1,1,2,2,3,4,5,5,6,6,7,7,7-tetradecafluoro-3-heptene (GWP: less than 10).

The fluorine-containing resin and the perfluoroalkene solvent were mixed so that the concentration of the fluorine-containing resin in the resulting fluorine-containing resin composition would be 5 mass %. The glass screw tube was sealed and then heated at 50° C. for 3 hours to dissolve the fluorine-containing resin in the perfluoroalkene solvent.

### [Evaluation of Fluorine-Containing Resin Composition]

### (1) Measurement of Viscosity

The Viscosity at 25° C. was Measured for the Fluorine-Containing Resin Composition produced by the above method. Specifically, the viscosity of the fluorine-containing resin composition at 25° C. was measured using an E-type viscometer (TVE-22LT manufactured by Toki Sangyo Co., Ltd.) by a test method specified in JIS K 7117-2. Table 1 shows the measurement results.

### (2) Evaluation of Filterability

The filterability was evaluated for the fluorine-containing resin composition produced by the above method. A tank-equipped stainless steel holder KST-47 manufactured by Advantec MFS, Inc. was used for the filterability evaluation. An omnipore membrane filter (property: hydrophilic; material: polytetrafluoroethylene (PTFE); pore diameter: 0.1 μm) manufactured by Merck KGaA was used as a filter. The filterability was judged by whether filtration of all of the solution in the tank of the tank-equipped stainless steel holder was achievable within eight hours. Table 1 shows the evaluation results. In Table 1, “A” means that all of the solution was filtered successfully within the time given, while “B” means that not all of the solution was filtered successfully. Whether filtration succeeded was judged visually.

### (3) Process Material Elution Test

An elution test of polypropylene (PP) and silicone which can be used as process materials was performed for the solvent, namely, 1,1,1,2,2,3,4,5,5,6,6,7,7,7-tetradecafluoro-3-heptene in the case of Example 1, used to produce the fluorine-containing resin composition. Test pieces (tubes each having an inner diameter of 9 mm, an outer diameter of 12 mm, and a length of 30 mm) made of PP and silicone and the solvent were put into a screw cap bottle. The test pieces were immersed in the solvent at room temperature for two weeks such that the unit contact area of each test piece would be approximately 20 mm² relative to 1 g of the solvent (i.e., such that the area of each test piece per gram of the solvent would be approximately 20 mm²). Two weeks later, the amounts of increase of the materials (PP and silicone) of the test pieces in the solvent were measured. The amounts of increase of the materials of the test pieces in the solvent were measured by gas chromatography (GC). When the amounts of increase of the materials of the test pieces in the solvent were 10 ppm or less for PP and 100 ppm or less for silicone, it was judged that elution of the process materials was reduced. Table 1 shows the results. In Table 1, “A” means that elution of the process materials was reduced, while “B” means that elution of the process materials was not reduced.

### Example 2

### [Production of Fluorine-Containing Resin]

A fluorine-containing resin was produced in the same manner as in Example 1.

### [Production of Fluorine-Containing Resin Composition]

A fluorine-containing resin composition of Example 2 was produced in the same manner as in Example 1, except that the fluorine-containing resin and the perfluoroalkene solvent were mixed so that the concentration of the fluorine-containing resin in the resulting fluorine-containing resin composition would be 10 mass %.

### [Evaluation of Fluorine-Containing Resin Composition]

Evaluation was performed in the same manner as in Example 1. Table 1 shows the evaluation results.

### Example 3

### [Production of Fluorine-Containing Resin]

A fluorine-containing resin was produced in the same manner as in Example 1.

### [Production of Fluorine-Containing Resin Composition]

A fluorine-containing resin composition of Example 3 was produced in the same manner as in Example 1, except that the fluorine-containing resin and the perfluoroalkene solvent were mixed so that the concentration of the fluorine-containing resin in the resulting fluorine-containing resin composition would be 19.5 mass %.

### [Evaluation of Fluorine-Containing Resin Composition]

Evaluation was performed in the same manner as in Example 1. Table 1 shows the evaluation results.

### Example 4

### [Production of Fluorine-Containing Resin]

A fluorine-containing resin was produced in the same manner as in Example 1.

### [Production of Fluorine-Containing Resin Composition]

A fluorine-containing resin composition of Example 4 was produced in the same manner as in Example 1, except that the fluorine-containing resin and the perfluoroalkene solvent were mixed so that the concentration of the fluorine-containing resin in the resulting fluorine-containing resin composition would be 20 mass %.

### [Evaluation of Fluorine-Containing Resin Composition]

Evaluation was performed in the same manner as in Example 1. Table 1 shows the evaluation results.

### Comparative Example 1

### [Production of Fluorine-Containing Resin]

A fluorine-containing resin was produced in the same manner as in Example 1.

### [Production of Fluorine-Containing Resin Composition]

A fluorine-containing resin composition of Comparative Example 1 was produced in the same manner as in Example 4, except that 1,1,1,2,2,3,4,5,5,5-decafluoropentane (GWP: 1640) was used as the solvent instead of 1,1,1,2,2,3,4,5,5,6,6,7,7,7-tetradecafluoro-3-heptene.

### [Evaluation of Fluorine-Containing Resin Composition]

Evaluation was performed in the same manner as in Example 1. Table 1 shows the evaluation results.

### Comparative Example 2

### [Production of Fluorine-Containing Resin]

A fluorine-containing resin was produced in the same manner as in Example 1.

### [Production of Fluorine-Containing Resin Composition]

A fluorine-containing resin composition of Comparative Example 2 was produced in the same manner as in Example 4, except that methyl nonafluoroisobutyl ether (Novec 7100 (manufactured by 3M Company)) (GWP: 297) was used as the solvent instead of 1,1,1,2,2,3,4,5,5,6,6,7,7,7-tetradecafluoro-3-heptene.

### [Evaluation of Fluorine-Containing Resin Composition]

Evaluation was performed in the same manner as in Example 1. Table 1 shows the evaluation results.

TABLE 1

| | | | Concentration | | | Elution of | |
|---|---|---|---|---|---|---|---|
| | Fluorine- | | of fluorine- | Viscosity | | process | |
| | containing | | containing | (25° C.) | | materials | |
| | resin | Solvent | resin [mass %] | [mPa · s] | Filterability | PP | Silicone |
| Example 1 | PFMMD | 1,1,1,2,2,3,4,5,5,6,6,7,7,7- | 5 | 3 | A | A | A |
| | | Tetradecafluoro-3- | | | | | |
| | | heptene | | | | | |
| Example 2 | PFMMD | 1,1,1,2,2,3,4,5,5,6,6,7,7,7- | 10 | 9 | A | A | A |
| | | Tetradecafluoro-3- | | | | | |
| | | heptene | | | | | |
| Example 3 | PFMMD | 1,1,1,2,2,3,4,5,5,6,6,7,7,7- | 19.5 | 98 | A | A | A |
| | | Tetradecafluoro-3- | | | | | |
| | | heptene | | | | | |
| Example 4 | PFMMD | 1,1,1,2,2,3,4,5,5,6,6,7,7,7- | 20 | 110 | B | A | A |
| | | Tetradecafluoro-3- | | | | | |
| | | heptene | | | | | |
| Comparative | PFMMD | 1,1,1,2,2,3,4,5,5,5- | 20 | 396 | B | B | B |
| Example 1 | | Decafluoropentane | | | | | |
| Comparative | PFMMD | Methyl nonafluoroisobutyl | 20 | 330 | B | B | B |
| Example 2 | | ether | | | | | |

As shown in Table 1, elution into the fluorine-containing resin compositions of Examples 1 to 4 including the perfluoroalkene as the solvent was reduced for both of the process materials, PP and silicone, in the process material elution test. This confirms that since including the perfluoroalkene having a low GWP as a solvent, the fluorine-containing resin compositions of Examples 1 to 4 can lessen an environmental impact and can also suppress elution of the process materials to reduce intrusion of impurities through a process. On the other hand, the solvents included in the fluorine-containing resin compositions of Comparative Examples 1 and 2 have a higher GWP than that of the perfluoroalkene used in Examples 1 to 4. Because of this, the fluorine-containing resin compositions of Comparative Examples 1 and 2 are inferior to the fluorine-containing resin compositions of Examples 1 to 4 in terms of lessening an environmental impact. Furthermore, the fluorine-containing resin compositions of Comparative Examples 1 and 2 were unable to suppress elution of the process materials.

The viscosities of the fluorine-containing resin compositions of Examples 1 to 3 at 25° C. are less than 110 mPa·s, which demonstrates achievement of excellent filterability. The fluorine-containing resin composition of Example 4 was unable to achieve a viscosity less than 110 mPa·s because the concentration of the fluorine-containing resin is high compared to those of Examples 1 to 3. However, compared to the fluorine-containing resin compositions of Comparative Examples 1 and 2 in which the concentration of the fluorine-containing resin is the same as that of Example 4, the fluorine-containing resin composition of Example 4 has a greatly reduced viscosity. Hence, the fluorine-containing resin composition of Example 4 is considered superior to the fluorine-containing resin compositions of Comparative Examples 1 and 2 also in filterability.

Incidentally, the elution test results only for PP and silicone as process materials are shown for Examples and Comparative Examples; however, elution into the solvents was examined also for other process materials such as PTFE, PFA, nylon 66, and HASTELLOY C276. There were smaller differences between the amounts of each of these process materials eluted into the solvents of Examples and Comparative Examples than in the cases of PP and silicone; however, the amounts of the process materials eluted into the perfluoroalkene solvent used in Examples were smaller than the amounts of the process materials eluted into the solvents used in Comparative Examples 1 and 2.

### Supplement

In summary, the invention of the present disclosure has the following aspects.

(1)

A fluorine-containing resin composition for POFs, the fluorine-containing resin composition including:
a fluorine-containing resin; and
a solvent in which the fluorine-containing resin is dissolved, wherein
the solvent is a perfluoroalkene, and
the fluorine-containing resin includes a fluorine-containing polymer including a structural unit (A) represented by the following formula (1):

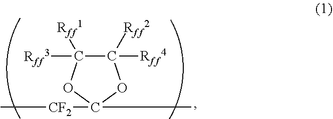

where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² are optionally linked to form a ring.
(2)

The fluorine-containing resin composition according to (1), wherein the fluorine-containing polymer further includes at least one selected from the group consisting of a structural unit (B) represented by the following formula (2), a structural unit (C) represented by the following formula (3), and a structural unit (D) represented by the following formula (4):

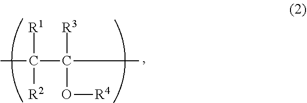

where R¹ to R³ each independently represent a fluorine atom or a perfluoroalkyl group having 1 to 7 carbon atoms, R⁴ represents a perfluoroalkyl group having 1 to 7 carbon atoms, the perfluoroalkyl group optionally has a ring structure, one or some of the fluorine atoms are each optionally substituted by a halogen atom other than a fluorine atom, and one or some of fluorine atoms in the perfluoroalkyl group are each optionally substituted by a halogen atom other than a fluorine atom;

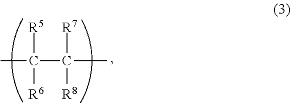

where R⁵ to R⁸ each independently represent a fluorine atom or a perfluoroalkyl group having 1 to 7 carbon atoms, the perfluoroalkyl group optionally has a ring structure, one or some of the fluorine atoms are each optionally substituted by a halogen atom other than a fluorine atom, and one or some of fluorine atoms in the perfluoroalkyl group are each optionally substituted by a halogen atom other than a fluorine atom; and

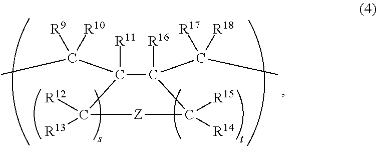

where Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms, one or some of the fluorine atoms are each optionally substituted by a halogen atom other than a fluorine atom, one or some of fluorine atoms in the perfluoroalkyl group are each optionally substituted by a halogen atom other than a fluorine atom, one or some of fluorine atoms in the perfluoroalkoxy group are each optionally substituted by a halogen atom other than a fluorine atom, s and t are each independently 0 to 5, and s+t is an integer of 1 to 6 or, in the case where Z is-OC(R¹⁹R²⁰)O—, s+t is optionally 0.
(3)

The fluorine-containing resin composition according to (1) or (2), wherein the structural unit (A) includes a structural unit represented by the following formula (5):

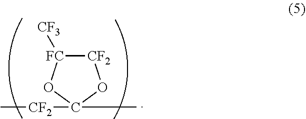

(4)

A fluorine-containing resin composition for POFs, the fluorine-containing resin composition including:
a fluorine-containing resin; and
a solvent in which the fluorine-containing resin is dissolved, wherein
the solvent is a perfluoroalkene, and
the fluorine-containing resin includes a fluorine-containing polymer including a structural unit (D) represented by the following formula (4):

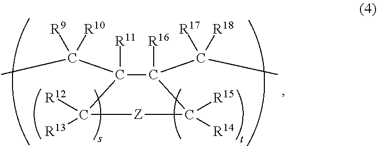

where Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms, one or some of the fluorine atoms are each optionally substituted by a halogen atom other than a fluorine atom, one or some of fluorine atoms in the perfluoroalkyl group are each optionally substituted by a halogen atom other than a fluorine atom, one or some of fluorine atoms in the perfluoroalkoxy group are each optionally substituted by a halogen atom other than a fluorine atom, s and t are each independently 0 to 5, and s+t is an integer of 1 to 6 or, in the case where Z is-OC(R¹⁹R²⁰)O—, s+t is optionally 0.
(5)

The fluorine-containing resin composition according to any one of (1) to (4), wherein the perfluoroalkene has 2 to 10 carbon atoms.

(6)

The fluorine-containing resin composition according to any one of (1) to (5), wherein the perfluoroalkene is represented by formula (12): CₙF₂ₙ, where n is an integer of 2 or more.

(7)

The fluorine-containing resin composition according to (6), wherein the perfluoroalkene is represented by formula (13): R²¹CF═CFR²², where R²¹ and R²² are each independently a perfluoroalkyl group having 1 to 6 carbon atoms.

(8)

The fluorine-containing resin composition according to (6) or (7), wherein the perfluoroalkene includes 1,1,1,2,2,3,4,5,5,6,6,7,7,7-tetradecafluoro-3-heptene.

(9)

The fluorine-containing resin composition according to any one of (1) to (4), wherein the perfluoroalkene is a cycloalkene.

(10)

The fluorine-containing resin composition according to (9), wherein the cycloalkene is represented by formula (15): cyclo-[CF═CF(CF₂)ₙ—], where n is an integer of 2 to 6.

(11)

The fluorine-containing resin composition according to any one of (1) to (10), wherein a concentration of the fluorine-containing resin in the fluorine-containing resin composition is less than 20 mass %.

(12)

The fluorine-containing resin composition according to any one of (1) to (11), wherein the fluorine-containing resin composition has a viscosity less than 110 mPa·s at 25° C.

(13)

A POF or a resin rod for POFs, the POF or the resin rod including the fluorine-containing resin composition according to any one of (1) to (12).

(14)

A method for manufacturing a resin formed body for POFs, the method including
(i) producing a resin formed body for POFs using the fluorine-containing resin composition according to any one of (1) to (12), the resin formed body including the fluorine-containing resin.
   (15)

The method according to (14), wherein in the step (i), the fluorine-containing resin composition is refined by filtration to give a resin material including the fluorine-containing resin composition and the resin material is formed to give the resin formed body including the fluorine-containing resin.

### INDUSTRIAL APPLICABILITY

The fluorine-containing resin composition for POFs according to the present invention is suitable for production of POFs.

What is claimed is:

1. A fluorine-containing resin composition for plastic optical fibers, the fluorine-containing resin composition comprising:
a fluorine-containing resin; and
a solvent in which the fluorine-containing resin is dissolved, wherein
the solvent is a perfluoroalkene, and
the fluorine-containing resin includes a fluorine-containing polymer including a structural unit (A) represented by the following formula (1): 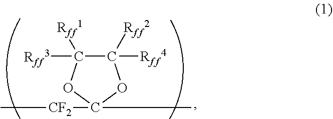
where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² are optionally linked to form a ring.

2. The fluorine-containing resin composition according to claim 1, wherein the fluorine-containing polymer further includes at least one selected from the group consisting of a structural unit (B) represented by the following formula (2), a structural unit (C) represented by the following formula (3), and a structural unit (D) represented by the following formula (4): 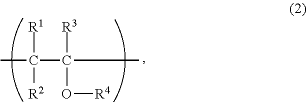
where R¹ to R³ each independently represent a fluorine atom or a perfluoroalkyl group having 1 to 7 carbon atoms, R⁴ represents a perfluoroalkyl group having 1 to 7 carbon atoms, the perfluoroalkyl group optionally has a ring structure, one or some of the fluorine atoms are each optionally substituted by a halogen atom other than a fluorine atom, and one or some of fluorine atoms in the perfluoroalkyl group are each optionally substituted by a halogen atom other than a fluorine atom; 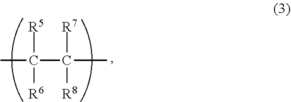
where R⁵ to R⁸ each independently represent a fluorine atom or a perfluoroalkyl group having 1 to 7 carbon atoms, the perfluoroalkyl group optionally has a ring structure, one or some of the fluorine atoms are each optionally substituted by a halogen atom other than a fluorine atom, and one or some of fluorine atoms in the perfluoroalkyl group are each optionally substituted by a halogen atom other than a fluorine atom; and 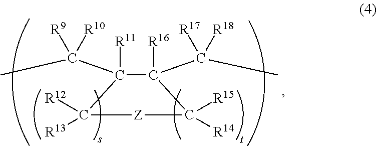
where Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms, one or some of the fluorine atoms are each optionally substituted by a halogen atom other than a fluorine atom, one or some of fluorine atoms in the perfluoroalkyl group are each optionally substituted by a halogen atom other than a fluorine atom, one or some of fluorine atoms in the perfluoroalkoxy group are each optionally substituted by a halogen atom other than a fluorine atom, s and t are each independently 0 to 5, and s+t is an integer of 1 to 6 or, in the case where Z is-OC(R¹⁹R²⁰)O—, s+t is optionally 0.

3. The fluorine-containing resin composition according to claim 1, wherein the structural unit (A) includes a structural unit represented by the following formula (5):

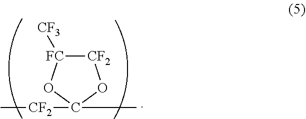

4. A fluorine-containing resin composition for plastic optical fibers, the fluorine-containing resin composition comprising:
a fluorine-containing resin; and
a solvent in which the fluorine-containing resin is dissolved, wherein
the solvent is a perfluoroalkene, and
the fluorine-containing resin includes a fluorine-containing polymer including a structural unit (D) represented by the following formula (4): 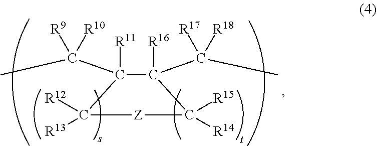
where Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms, one or some of the fluorine atoms are each optionally substituted by a halogen atom other than a fluorine atom, one or some of fluorine atoms in the perfluoroalkyl group are each optionally substituted by a halogen atom other than a fluorine atom, one or some of fluorine atoms in the perfluoroalkoxy group are each optionally substituted by a halogen atom other than a fluorine atom, s and t are each independently 0 to 5, and s+t is an integer of 1 to 6 or, in the case where Z is-OC(R¹⁹R²⁰)O—, s+t is optionally 0.

5. The fluorine-containing resin composition according to claim 1, wherein the perfluoroalkene has 2 to 10 carbon atoms.

6. The fluorine-containing resin composition according to claim 4, wherein the perfluoroalkene has 2 to 10 carbon atoms.

7. The fluorine-containing resin composition according to claim 1, wherein the perfluoroalkene is represented by formula (12): CₙF₂ₙ, where n is an integer of 2 or more.

8. The fluorine-containing resin composition according to claim 4, wherein the perfluoroalkene is represented by formula (12): CₙF₂ₙ, where n is an integer of 2 or more.

9. The fluorine-containing resin composition according to claim 7, wherein the perfluoroalkene is represented by formula (13): R²¹CF═CFR²², where R²¹ and R²² are each independently a perfluoroalkyl group having 1 to 6 carbon atoms.

10. The fluorine-containing resin composition according to claim 8, wherein the perfluoroalkene is represented by formula (13): R²¹CF═CFR²², where R²¹ and R²² are each independently a perfluoroalkyl group having 1 to 6 carbon atoms.

11. The fluorine-containing resin composition according to claim 7, wherein the perfluoroalkene includes 1,1,1,2,2,3,4,5,5,6,6,7,7,7-tetradecafluoro-3-heptene.

12. The fluorine-containing resin composition according to claim 8, wherein the perfluoroalkene includes 1,1,1,2,2,3,4,5,5,6,6,7,7,7-tetradecafluoro-3-heptene.

13. The fluorine-containing resin composition according to claim 1, wherein the perfluoroalkene is a cycloalkene.

14. The fluorine-containing resin composition according to claim 4, wherein the perfluoroalkene is a cycloalkene.

15. The fluorine-containing resin composition according to claim 13, wherein the cycloalkene is represented by formula (15): cyclo-[CF═CF(CF₂)ₙ—], where n is an integer of 2 to 6.

16. The fluorine-containing resin composition according to claim 14, wherein the cycloalkene is represented by formula (15): cyclo-[CF═CF(CF₂)ₙ—], where n is an integer of 2 to 6.

17. The fluorine-containing resin composition according to claim 1, wherein a concentration of the fluorine-containing resin in the fluorine-containing resin composition is less than 20 mass %.

18. The fluorine-containing resin composition according to claim 4, wherein a concentration of the fluorine-containing resin in the fluorine-containing resin composition is less than 20 mass %.

19. The fluorine-containing resin composition according to claim 1, wherein the fluorine-containing resin composition has a viscosity less than 110 mPa·s at 25° C.

20. The fluorine-containing resin composition according to claim 4, wherein the fluorine-containing resin composition has a viscosity less than 110 mPa·s at 25° C.
